(19) United States
(12) Patent Application Publication
(10) Pub. No.: US 2012/0095183 A1
(43) Pub. Date: Apr. 19, 2012

(54) METHODS OF PREPARING WHOLLY AROMATIC LIQUID CRYSTALLINE POLYESTER RESIN AND WHOLLY AROMATIC LIQUID CRYSTALLINE POLYESTER RESIN COMPOUND WITH CONSTANT MELT VISCOSITY

(75) Inventors: Sun Hwa Chang, Daejeon-city (KR); Mi Jeong Kim, Seoul (KR); Mahn Jong Kim, Daejeon-city (KR); Youn Eung Lee, Daejeon-city (KR); Young Hak Shin, Daejeon-city (KR); Jin Kyu Lee, Busan-city (KR)

(73) Assignee: SAMSUNG FINE CHEMICALS CO., LTD., Ulsan (KR)

(21) Appl. No.: 13/378,156

(22) PCT Filed: Jun. 16, 2010
(86) PCT No.: PCT/KR2010/003857

§ 371 Date: Dec. 14, 2011

(30) Foreign Application Priority Data
Jun. 17, 2009 (KR) 10-2009-0053986

(51) Int. Cl. C08G 63/80; C09K 19/38

(52) U.S. Cl. 528/305

(57) ABSTRACT

A method of preparing a wholly aromatic liquid crystalline polyester resin and a method of preparing a wholly aromatic liquid crystalline polyester resin compound. The method of preparing the wholly aromatic liquid crystalline polyester resin includes condensation poly-merizing raw 1 monomers including aromatic hydroxy carboxylic acid and a mixture of aromatic diol and aromatic dicarboxylic acid in a predetermined molar ratio. In addition, the method of preparing the wholly aromatic liquid crystalline polyester resin compound includes the method of preparing the wholly aromatic liquid crystalline polyester resin

### TECHNICAL FIELD

The present invention relates to a method of preparing a wholly aromatic liquid crystalline polyester resin and a method of preparing a wholly aromatic liquid crystalline polyester resin compound, and more particularly, to a method of preparing a wholly aromatic liquid crystalline polyester resin, the method including condensation polymerizing raw monomers including aromatic hydroxy carboxylic acid and a mixture of aromatic diol and aromatic dicarboxylic acid in a predetermined molar ratio, and a method of preparing a wholly aromatic liquid crystalline polyester resin compound, which includes the method of preparing the wholly aromatic liquid crystalline polyester resin.

### BACKGROUND ART

A wholly aromatic liquid crystalline polyester resin has rigid molecules and forms a liquid crystal state in which molecules are not entangled in a melting state, wherein chains of molecules are oriented in a flow direction of the wholly aromatic liquid crystalline polyester resin by a shear force while being molded.

Due to these properties, a wholly aromatic liquid crystalline polyester resin has excellent flowability and heat resistance so as to be widely used as materials for automobile parts, electric and electronic components, and small and fine molded products.

In particular, a wholly aromatic liquid crystalline polyester resin has excellent heat resistance since polymer main chains thereof are formed of aromatic groups so as to be used for coil bobbin that is soldered at high temperature or supporting components of high temperature electric heaters and photothermal devices. In addition, a wholly aromatic liquid crystalline polyester resin has excellent dimensional stability and electric insulation so as to be widely used for films for electronic devices and materials for substrates.

This wholly aromatic liquid crystalline polyester resin may be prepared by condensation polymerizing at least two monomers. When a wholly aromatic liquid crystalline polyester resin is processed at a temperature higher than its melting point, melt viscosity increases with time. Accordingly, it is difficult to process the wholly aromatic liquid crystalline polyester resin, and resin compounds and molded products thereof may have poor and non-uniform physical properties.

### DISCLOSURE OF INVENTION

### Technical Problem

The present invention provides a method of preparing a wholly aromatic liquid crystalline polyester resin, the method including condensation polymerizing raw monomers including aromatic hydroxy carboxylic acid and a mixture of aromatic diol and aromatic dicarboxylic acid in a predetermined molar ratio.

The present invention also provides a method of preparing a wholly aromatic liquid crystalline polyester resin compound, which includes the method of preparing the wholly aromatic liquid crystalline polyester resin.

### Solution to Problem

According to an aspect of the present invention, there is provided a method of preparing a wholly aromatic liquid crystalline polyester resin, the method including:

synthesizing a wholly aromatic liquid crystalline polyester prepolymer by condensation polymerization of raw monomers including aromatic hydroxy carboxylic acid, aromatic diol, and aromatic dicarboxylic acid,

wherein the amount of the aromatic dicarboxylic acid in the raw monomers is in the range of 1.02 to 1.08 parts by mole based on 1 part by mole of the aromatic diol.

The method may further include synthesizing a wholly aromatic liquid crystalline polyester resin by solid phase condensation polymerization of the prepolymer.

The raw monomers may further include at least one compound selected from the group consisting of aromatic diamine and aromatic hydroxylamine

The raw monomers may further include aromatic amino carboxylic acid.

The aromatic hydroxy carboxylic acid may include at least one compound selected from the group consisting of p-hydroxybenzoic acid and 2-hydroxy-6-naphthoic acid, the aromatic diol may include at least one compound selected from the group consisting of biphenol and hydroquinone, and the aromatic dicarboxylic acid may include at least one compound selected from the group consisting of isophthalic acid, naphthalenedicarboxylic acid, and terephthalic acid. The aromatic diamine may include at least one compound selected from the group consisting of 1,4-phenylene diamine, 1,3-phenylene diamine, and 2,6-naphthalene diamine, and the aromatic hydroxylamine may include at least one compound selected from the group consisting of 3-aminophenol, 4-aminophenol, and 2-amino-6-naphthol. The aromatic amino carboxylic acid may include at least one compound selected from the group consisting of 4-aminobenzoic acid, 2-amino-naphthalene-6-carboxylic acid, and 4-amino-biphenyl-4-carboxylic acid

According to another aspect of the present invention, there is provided a method of preparing a wholly aromatic liquid crystalline polyester resin compound, which includes the method of preparing a wholly aromatic liquid crystalline polyester resin.

### Advantageous Effects of Invention

According to an embodiment of the present invention, a method of preparing the wholly aromatic liquid crystalline polyester resin, the method including condensation polymerizing raw monomers including aromatic hydroxy carboxylic acid and a mixture of aromatic diol and aromatic dicarboxylic acid in a predetermined molar ratio, is provided. By the method, melt viscosity of the wholly aromatic liquid crystalline polyester resin is constantly maintained with time during a high-temperature processing performed at a temperature higher than the melting point of the wholly aromatic liquid crystalline polyester resin, and the wholly aromatic liquid crystalline polyester resin has uniform and excellent physical properties.

According to another embodiment of the present invention, a method of preparing the wholly aromatic liquid crystalline polyester resin compound, which includes the method of preparing the wholly aromatic liquid crystalline polyester resin, is provided.

### Mode for the Invention

Hereinafter, a method of preparing a wholly aromatic liquid crystalline polyester resin and a method of preparing a wholly aromatic liquid crystalline polyester resin compound, which includes the method of preparing the wholly aromatic liquid crystalline polyester resin according to the present invention, will now be described in detail.

A method of preparing a wholly aromatic liquid crystalline polyester resin, according to an embodiment of the present invention, includes synthesizing a wholly aromatic liquid crystalline polyester prepolymer by condensation polymerization of raw monomers including aromatic hydroxy carboxylic acid, aromatic diol, and aromatic dicarboxylic acid, wherein the amount of the aromatic dicarboxylic acid in the raw monomers is in the range of 1.02 to 1.08 parts by mole based on 1 part by mole of the aromatic diol.

The aromatic hydroxy carboxylic acid may include at least one compound selected from the group consisting of p-hydroxybenzoic acid and 2-hydroxy-6-naphthoic acid, the aromatic diol may include at least one compound selected from the group consisting of biphenol and hydroquinone, and the aromatic dicarboxylic acid may include at least one compound selected from the group consisting of isophthalic acid, naphthalenedicarboxylic acid, and terephthalic acid.

When the amount of the aromatic diol in the raw monomers is less than 1.02 parts by mole based on 1 part by mole of the aromatic dicarboxylic acid, melt viscosity of the wholly aromatic liquid crystalline polyester resin rapidly increases with time at a temperature higher than the melting point of the wholly aromatic liquid crystalline polyester resin while processing the wholly aromatic liquid crystalline polyester resin at a high temperature, thereby causing defects in processing. In order to reduce the melt viscosity to prevent the defects caused during the processing, the processing temperature is required to be increased. However, if the processing temperature increases, the wholly aromatic liquid crystalline polyester resin is thermally decomposed, so that mechanical properties and thermal properties of the wholly aromatic liquid crystalline polyester resin compound prepared by the high-temperature processing may deteriorate. In addition, if the processing temperature is changed to constantly maintain the melt viscosity during the high-temperature processing, physical properties of the wholly aromatic liquid crystalline polyester resin compound and injection-molded products thereof may not be uniform.

In addition, when the amount of the aromatic diol in the raw monomers is greater than 1.08 parts by mole based on 1 part by mole of the aromatic dicarboxylic acid, the amount of gas generated during the high-temperature processing of the synthesized wholly aromatic liquid crystalline polyester resin increases so as to occlude a vacuum pipe. Thus, the processing may not be continued, the melt viscosity of the synthesized wholly aromatic liquid crystalline polyester resin compound may decrease, and mechanical properties and thermal properties of the resin compound may deteriorate.

Thus, the wholly aromatic liquid crystalline polyester resin prepared according to method according to the current embodiment has uniform and excellent physical properties. Since the melt viscosity of the wholly aromatic liquid crystalline polyester resin is not changed with time during the high-temperature processing, the resin may be processed at a constant temperature and at a constant shear rate, so that the prepared resin compound may also have excellent mechanical properties and thermal properties.

In addition, the raw monomers may further include at least one compound selected from the group consisting of aromatic diamine and aromatic hydroxylamine. The aromatic diamine may include at least one compound selected from the group consisting of 1,4-phenylene diamine, 1,3-phenylene diamine, and 2,6-naphthalene diamine, and the aromatic hydroxylamine may include at least one compound selected from the group consisting of 3-aminophenol, 4-aminophenol, and 2-amino-6-naphthol.

In addition, the raw monomers may further include aromatic amino carboxylic acid. The aromatic amino carboxylic acid may include at least one compound selected from the group consisting of 4-aminobenzoic acid, 2-amino-naphthalene-6-carboxylic acid, and 4-amino-biphenyl-4-carboxylic acid.

In addition, the raw monomers may include a monomer whose reactivity is increased (i.e., acylated monomer) by pre-treating it with chemicals such as an acylating agent (particularly, acetylating agent) in order to expedite the condensation polymerization.

In addition, the synthesizing the wholly aromatic liquid crystalline polyester prepolymer may be conducted by solution condensation polymerization or bulk condensation polymerization.

In addition, metal acetate may further be used as a catalyst expediting the synthesis of the wholly aromatic liquid crystalline polyester prepolymer. The metal acetate may include at least one selected from the group consisting of magnesium acetate, potassium acetate, calcium acetate, zinc acetate, manganese acetate, lead acetate, antimony acetate, and cobalt acetate. The amount of the metal acetate may be in the range of 0.01 to 0.10 parts by weight based on 100 parts by weight of the raw monomers.

The method of preparing the wholly aromatic liquid crystalline polyester resin may further include synthesizing the wholly aromatic liquid crystalline polyester resin by solid phase condensation polymerization of the prepolymer.

For the solid phase condensation polymerization in the synthesis of the wholly aromatic liquid crystalline polyester resin, the prepolymer is required to be heated using a heating plate, hot air, hot fluid, or the like. By-products produced during the solid phase condensation polymerization may be removed by purging with inert gas or by applying vacuum thereto.

In addition, the wholly aromatic liquid crystalline polyester resin synthesized according to the method includes a variety of repeating units in its chain. For example, the repeating units are as follows:

(1) Repeating unit derived from aromatic diol:

—O—Ar—O—

(2) Repeating unit derived from aromatic dicarboxylic acid:

—OC—Ar—CO—

(3) Repeating unit derived from aromatic hydroxy carboxylic acid:

—O—Ar—CO—

(4) Repeating unit derived from aromatic diamine:

—HN—Ar—NH—

(5) Repeating unit derived from aromatic hydroxylamine:

—HN—Ar—O—

(6) Repeating unit derived from aromatic amino carboxylic acid:

—HN—Ar—CO—

In the formulae of the repeating units, Ar may be an aromatic compound selected from the group consisting of phenylene, biphenylene, naphthalene, or two phenylene connected to each other by carbon or a non-carbon element, or an aromatic compound selected from the group consisting of phenylene, biphenylene, naphthalene, or two phenylene connected to each other by carbon or a non-carbon element in which at least one hydrogen atom is substituted with other elements.

According to another embodiment of the present invention, there is provided a method of preparing a wholly aromatic liquid crystalline polyester resin compound, which includes the method of preparing the wholly aromatic liquid crystalline polyester resin.

The method of preparing the wholly aromatic liquid crystalline polyester resin compound includes: synthesizing a wholly aromatic liquid crystalline polyester resin according to the method of preparing a wholly aromatic liquid crystalline polyester resin described above; and melt-kneading the synthesized wholly aromatic liquid crystalline polyester resin and an additive. In the melt-kneading, a batch kneader, a twin-screw extruder, or a mixing roll may be used. In addition, a lubricant may be used during the melt-kneading for smooth melt-kneading.

The additive may include at least one selected from the group consisting of an inorganic additive and an organic additive.

The inorganic additive may be glass fiber, talc, calcium carbonate, mica, or any mixture of at least two thereof, and the organic additive may be carbon fiber.

Hereinafter, one or more embodiments will be described in detail with reference to the following examples. However, these examples are not intended to limit the purpose and scope of the invention.

### EXAMPLES

### Example 1

### Preparation of Wholly Aromatic Liquid Crystalline Polyester Resin (1) and Resin Compound Thereof (1)

24.7 kg (178.8 mol) of p-hydroxybenzoic acid, 11.0 kg (59.1 mol) of biphenol, 8.55 kg (51.5 mol) of terephthalic acid, and 1.6 kg (9.6 mol) of isophthalic acid were added to a 100 L batch reactor (SUS 316L), the temperature of which is controllable. Nitrogen gas was injected to the reactor, and then 33.4 kg (327.2 mol) of acetic anhydride was added thereto. Then, 15 g of magnesium acetate and 3 g of potassium acetate were further added to the reactor to facilitate condensation polymerization that will be described later. Then, the temperature of the reactor was increased up to 150° C. for 30 minutes and the reactor content was refluxed at 150° C. for 3 hours. Then, the temperature of the reactor was increased up to 330° C. for 6 hours while removing acetic acid, which is a by-product to perform condensation polymerization of the monomers, to prepare a wholly aromatic liquid crystalline polyester prepolymer. Then, the wholly aromatic liquid crystalline polyester prepolymer was collected from the reactor and cooled and solidified. Then, the wholly aromatic liquid crystalline polyester prepolymer was pulverized to an average particle diameter of 1 mm using a pulverizer. Then, 20 kg of the wholly aromatic liquid crystalline polyester prepolymer having a uniform particle size was added to a 100 L rotary kiln reactor, and the temperature of the reactor was increased up to 200° C., where weight loss is initiated, for 1 hour, while flowing nitrogen at a rate of 1 Nm³/hr. Then, the temperature of the reactor was increased up to 320° C. for 10 hours and maintained at 320° C. for 3 hours to prepare a wholly aromatic liquid crystalline polyester resin (1). Then, the reactor was cooled at room temperature for 1 hour, and the wholly aromatic liquid crystalline polyester resin (1) was collected from the reactor.

Then, the prepared wholly aromatic liquid crystalline polyester resin (1) and glass fiber (pulverized glass fiber having a diameter of 10 μm and an average length of 150 μm) were mixed in a weight ratio of 6:4, and the mixture was melt-kneaded using a twin-screw extruder (L/D: 40, diameter: 20 mm) to prepare a wholly aromatic liquid crystalline polyester resin compound (1). By-products were removed by applying vacuum to the twin-screw extruder during the preparation of the wholly aromatic liquid crystalline polyester resin compound (1).

### Example 2

### Preparation of Wholly Aromatic Liquid Crystalline Polyester Resin (2) and Resin Compound Thereof (2)

A wholly aromatic liquid crystalline polyester resin (2) and a resin compound thereof (2) were prepared in the same manner as in Example 1, except that 10.7 kg (57.5 mol) of biphenol was used.

### Comparative Example 1

### Preparation of Wholly Aromatic Liquid Crystalline Polyester Resin (3) and Resin Compound Thereof (3)

A wholly aromatic liquid crystalline polyester resin (3) and a resin compound thereof (3) were prepared in the same manner as in Example 1, except that 11.4 kg (61.2 mol) of biphenol was used.

### Comparative Example 2

### Preparation of Wholly Aromatic Liquid Crystalline Polyester Resin (4) and Resin Compound Thereof (4)

A wholly aromatic liquid crystalline polyester resin (4) and a resin compound thereof (4) were prepared in the same manner as in Example 1, except that 10.3 kg (55.3 mol) of biphenol was used.

### Evaluation Examples

Melt viscosity, changes of melt viscosity with time, and melting point of the wholly aromatic liquid crystalline polyester resins prepared according to Examples 1 and 2 and Comparative Examples 1 and 2, melt viscosity, changes of melt viscosity with time, tensile strength, flexural strength, impact intensity, and deflection temperature of the wholly aromatic liquid crystalline polyester resin compounds prepared according to Examples 1 and 2 and Comparative Examples 1 and 2 were measured, and the results are shown in Table 1 below.

Measuring Physical Properties of Wholly Aromatic Liquid Crystalline Polyester Resin

(1) Measuring Melting Point

Melting point was measured using a differential scanning calorimeter (TA Instruments Inc., DSC 2910). A temperature at which an endothermic peak was observed while a resin sample was heated from 40° C. at a rate of 20° C./min was determined as a first melting point (Tm1). While the resin sample was maintained at a temperature 30° C. higher than Tm1 for 10 minutes, cooled to 40° C. at a rate of 10° C./min, and heated at a rate of 20° C./min, a temperature at which the endothermic peak was observed was determined as melting point.

(2) Measuring Melt Viscosity and Changes of Melt Viscosity with Time

A viscosity was measured using a melt viscosity measuring device (Rosand, Inc., RH2000) having a 10 mm×2 mm capillary, at a temperature 10° C. higher than the melting point and at a shear rate of 1000/s, and the measured viscosity was regarded as melt viscosity. Then, after 20 minutes, a viscosity was measured again at the same temperature and the same shear rate as the above, and the viscosity difference was determined as change of melt viscosity.

Measuring Physical Properties of Wholly Aromatic Liquid Crystalline Polyester Resin Compound

Samples of the wholly aromatic liquid crystalline polyester resin compounds were prepared using an extruder (FANUC Co. Ltd, S-2000i 50B), cooled to room temperature, and maintained at room temperature for 5 hours. Then, tensile strength (ASTM D638), flexural strength (ASTM D790), impact intensity (ASTM D256), and deflection temperature (ASTM D648) of the samples were measured.

TABLE 1

| | | | Melt visosity | | | | | |
|---|---|---|---|---|---|---|---|---|
| | Melt | | of resin | | | | | |
| | viscosity of | | compound | | Tensile | Flexural | Impact | Deflection |
| | resin (poise) | | (poise) | | strength | strength | intensity | temperature |
| | 0 min | 20 min | 0 min | 20 min | (MPa) | (MPa) | (J/m) | (□) |
| Example 1 | 810 | 1170 | 720 | 1040 | 131 | 158 | 903 | 325 |
| Example 2 | 730 | 1220 | 650 | 1080 | 127 | 153 | 880 | 322 |
| Comparative | 1100 | 6800 | 690 | 2770 | 116 | 138 | 702 | 311 |
| Example 1 | | | | | | | | |
| Comparative | 670 | 4750 | 440 | 2320 | 109 | 132 | 560 | 304 |
| Example 2 | | | | | | | | |

Referring to Table 1, the change of melt viscosity of the wholly aromatic liquid crystalline polyester resin or the wholly aromatic liquid crystalline polyester resin compound prepared according to Examples 1 and 2 was far less than that of the wholly aromatic liquid crystalline polyester resin or the wholly aromatic liquid crystalline polyester resin compound prepared according to Comparative Examples 1 and 2. Accordingly, the wholly aromatic liquid crystalline polyester resin compound prepared according to Examples 1 and 2 had better physical properties than the wholly aromatic liquid crystalline polyester resin compound prepared according to Comparative Examples 1 and 2.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a wholly aromatic liquid crystalline polyester resin, the method comprising:
synthesizing a wholly aromatic liquid crystalline polyester prepolymer by condensation polymerization of raw monomers comprising aromatic hydroxy carboxylic acid, aromatic diol, and aromatic dicarboxylic acid, wherein the amount of the aromatic dicarboxylic acid in the raw monomers is in the range of 1.02 to 1.08 parts by mole based on 1 part by mole of the aromatic diol.

2. The method of claim 1, further comprising synthesizing a wholly aromatic liquid crystalline polyester resin by solid phase condensation polymerization of the prepolymer.

3. The method of claim 1, wherein the raw monomers further comprises at least one compound selected from the group consisting of aromatic diamine and aromatic hydroxylamine.

4. The method of claim 1, wherein the raw monomers further comprises aromatic amino carboxylic acid.

5. The method of claim 4, wherein the aromatic amino carboxylic acid comprises at least one compound selected from the group consisting of 4-aminobenzoic acid, 2-amino-naphthalene-6-carboxylic acid, and 4-amino-biphenyl-4-carboxylic acid.

6. The method of claim 3, wherein the aromatic diamine comprises at least one compound selected from the group consisting of 1,4-phenylene diamine, 1,3-phenylene diamine, and 2,6-naphthalene diamine, and the aromatic hydroxylamine comprises at least one compound selected from the group consisting of 3-aminophenol, 4-aminophenol, and 2-amino-6-naphthol.

7. The method of claim 1, wherein the aromatic hydroxy carboxylic acid comprises at least one compound selected from the group consisting of p-hydroxybenzoic acid and 2-hydroxy-6-naphthoic acid, the aromatic diol comprises at least one compound selected from the group consisting of biphenol and hydroquinone, and the aromatic dicarboxylic acid comprises at least one compound selected from the group consisting of isophthalic acid, naphthalenedicarboxylic acid, and terephthalic acid.

8. A method of preparing a wholly aromatic liquid crystalline polyester resin compound, which comprises the method of preparing a wholly aromatic liquid crystalline polyester resin according to claim 1.

9. A method of preparing a wholly aromatic liquid crystalline polyester resin compound, which comprises the method of preparing a wholly aromatic liquid crystalline polyester resin according to claim 2.

10. A method of preparing a wholly aromatic liquid crystalline polyester resin compound, which comprises the method of preparing a wholly aromatic liquid crystalline polyester resin according to claim 3.

11. A method of preparing a wholly aromatic liquid crystalline polyester resin compound, which comprises the method of preparing a wholly aromatic liquid crystalline polyester resin according to claim 4.

12. A method of preparing a wholly aromatic liquid crystalline polyester resin compound, which comprises the method of preparing a wholly aromatic liquid crystalline polyester resin according to claim 5.

13. A method of preparing a wholly aromatic liquid crystalline polyester resin compound, which comprises the method of preparing a wholly aromatic liquid crystalline polyester resin according to claim 6.

14. A method of preparing a wholly aromatic liquid crystalline polyester resin compound, which comprises the method of preparing a wholly aromatic liquid crystalline polyester resin according to claim 7.
